(19) United States
(12) Patent Application Publication
(10) Pub. No.: US 2009/0044696 A1
(43) Pub. Date: Feb. 19, 2009

(54) Fluid Pressure Type Actuator

(76) Inventors: Takumi Inakazu, Tokyo (JP); Yutaka Sato, Tokyo (JP); Kazuaki Hiramatsu, Tokyo (JP); Makoto Konami, Tokyo (JP); Taisuke Matsushita, Tokyo (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 12/094,019

(22) PCT Filed: Nov. 6, 2006
(86) PCT No.: PCT/JP2006/322075

§ 371 Date: May 16, 2008

(30) Foreign Application Priority Data
Nov. 18, 2005 (JP) 2005-333947

(51) Int. Cl. F15B 15/08

(52) U.S. Cl. 92/92; 92/48; 92/89; 92/105

(57) ABSTRACT

In order to improve its durability, a fluid pressure type actuator is comprises an expansible/contractible body having opposite ends sealed by plug members and expands/contracts when fluid is supplied to and discharged from the body; a wrapping body for wrapping the outer peripheral surface of the expansible/contractible body and having its opposite ends fastened and fixed to the plug members; an inlet/outlet for fluid formed in the plug members; and an auxiliary member for preventing or suppressing local deformation in which the wrapping body expands outward when the fluid is supplied to the expansible/contractible body.

### TECHNICAL FIELD

The present invention is related to a fluid pressure type actuator driven by supply/discharge of fluid such as air.

### BACKGROUND ART

Recently, the use of an elastic expansion body disclosed in documents such as Patent Document 1˜Patent Document 3 (hereinafter referred to as a fluid pressure type actuator) as a drive source of the equipment has been suggested.

In the conventional fluid pressure type actuator, for example, a pneumatic actuator, the outer periphery of a rubber tube is wrapped by a non-elastic net-like wrapping body, and the diameter of the wrapping body gets increased by expansion of the tube due to supply of air. The increment of the diameter of the wrapping body leads to reduction of its length, and driving force is generated by the reduction of length.

Patent Document 1: JP-A-H7-24771

Patent Document 2: JP-A-2002-103270

Patent Document 3: WO2004/085856

### DISCLOSURE OF THE INVENTION

### Problems to be Solved

The pneumatic actuator disclosed in the above-mentioned Documents has a problem that when expansion and contraction are repeated many times, the mesh of the wrapping body starts falling apart along with the increase of the number of repetitions. For example, the present inventor found out that when air is supplied to a pneumatic actuator to obtain driving force, the vicinity of opposite ends of the pneumatic actuator in longitudinal direction expand in spherical form, and the size of the mesh of the wrapping body expands larger than the intermediate portion of the actuator in longitudinal direction. In this way, when the mesh of the wrapping body is enlarged, a part of the rubber tube expanded due to supply of air protrudes from the mesh, which leads to a damage of the tube being pinched in the gaps between the mesh. For example, according to the experiment performed by the present inventor, it has been proved that a certain type of pneumatic actuator, when expansion/contraction is repeated at a frequency of 4 times/minute, gets damaged after a few tens thousands of times of repetition. When the tube is damaged, it causes leakage of the air supplied to the tube, whereby impairing the function of the pneumatic actuator.

The objective of the present invention is to solve the above-mentioned problem by improving the durability of the pneumatic actuator.

### Means to Solve the Problem

The fluid pressure type actuator of the present invention is characterized in comprising:

an expansible/contractible body which is sealed by plug members on opposite ends, and expands/contracts by supply/discharge of fluid;

a wrapping body which wraps the outer periphery of the expansible/contractible body, and having its opposite ends fastened and fixed to the plug members;

an inlet/outlet of fluid formed in the plug members; and

an auxiliary member for preventing or suppressing local deformation in which the wrapping body expands outwards when the fluid is supplied to the expansible/contractible body.

In accordance with the present invention, the number of repeated expansions/contractions until the local deformation takes place at the end portions of the wrapping body (durability) is substantially increased by comprising the auxiliary member.

### BRIEF DESCRIPTION OF THE DIAGRAMS

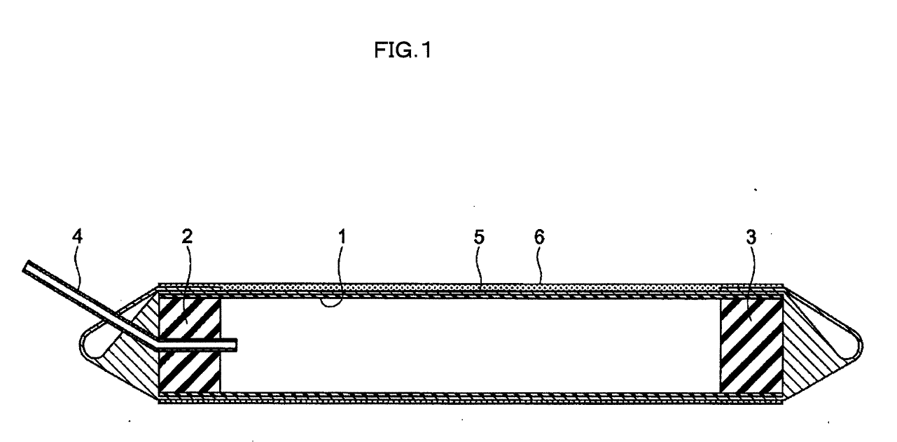

FIG. 1 shows a vertical cross-sectional view of the pneumatic actuator by embodiment 1 of the present invention.

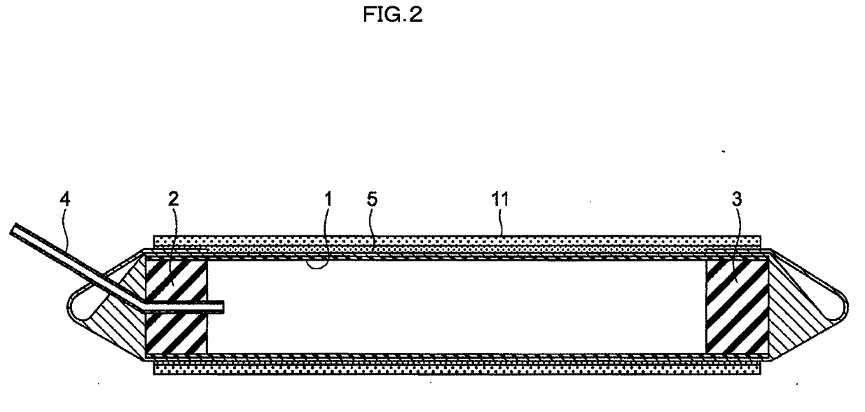

FIG. 2 shows a vertical cross-sectional view of the pneumatic actuator by embodiment 2 of the present invention.

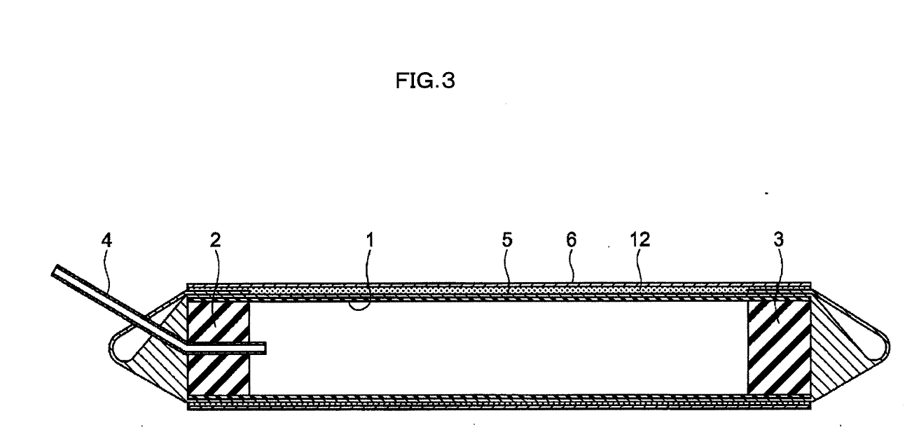

FIG. 3 shows a vertical cross-sectional view of the pneumatic actuator by embodiment 2 of the present invention.

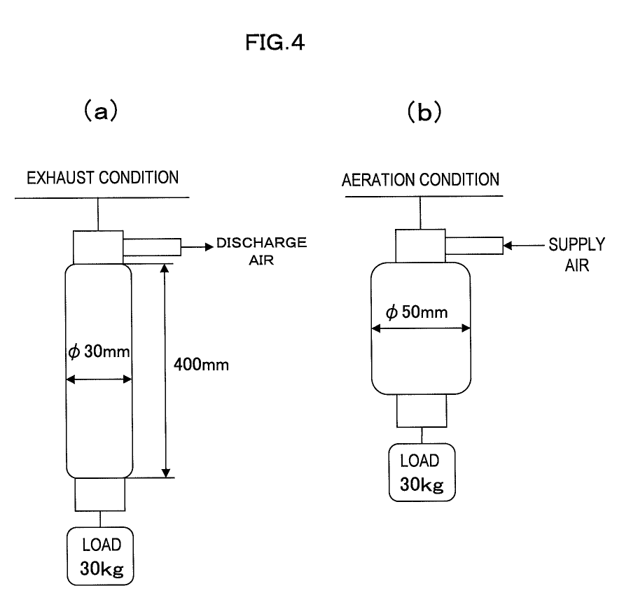

FIG. 4 shows a method for a durability test of the pneumatic actuator.

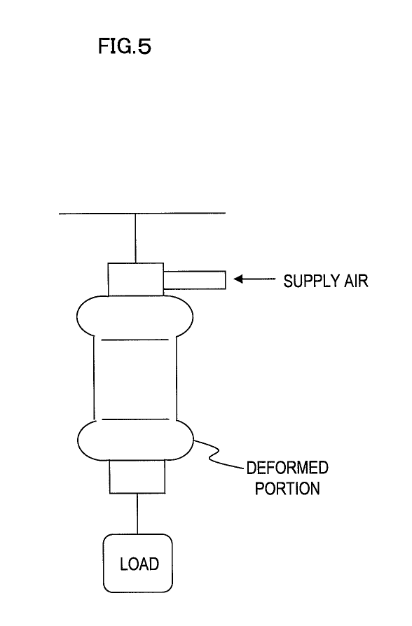

FIG. 5 shows a local deformation in the end portions of the conventional pneumatic actuator.

### BEST MODE FOR CARRYING OUT THE INVENTION

Hereinafter, an embodiment of the present invention will be described referring to the diagrams.

FIG. 1 shows a vertical cross-sectional view of the pneumatic actuator by embodiment 1 of the present invention. As shown in FIG. 1, a pneumatic actuator of embodiment 1 related to the present invention comprises:

a rubber tube (hereinafter referred to as an inner tube) 1 which expands by air supply;

rubber plugs 2 and 3 for sealing opposite ends of the inner tube 1;

an air supply/discharge tube 4 which is formed to pass through the rubber plug 2 and to reach the internal space of the inner tube 1;

a first net-like wrapping body (hereinafter referred to as a first mesh sleeve) 5 which wraps the outer periphery of the inner tube 1;

a second net-like wrapping body (hereinafter referred to as a second mesh sleeve) 6 which wraps the outer periphery of the first mesh sleeve 5; and

a stopper (not shown) which fastens and fixes the mesh sleeves 5 and 6 to the rubber plugs 2 and 3. To the air supply/discharge tube 4, an air supply/discharge device not shown in the diagram, for example, an air compressor is connected, and the pneumatic actuator is driven by the air supplied from the air compressor into the inner tube 1 via the air supply/discharge device, or by discharge of the air from the inner tube 1.

The outer periphery of the inner tube 1 is covered by the first net-like mesh sleeve 5, and the outer periphery of the first net-like mesh sleeve 5 which covers the outer periphery of the inner tube 1 is covered by the second mesh sleeve 6. These mesh sleeves 5 and 6 can have the same material and thickness of the wire rod (filament), number of wires for forming the mesh, and the diameter of the mesh. In other words, the mesh sleeves 5 and 6 form a twofold structure. The mesh sleeves 5 and 6 are braided by a resin having extremely small dilation with respect to a load, for example, a wire rod (filament) of a high tension fiber such as a nylon fiber or polyester, and the mesh is braided so as to cross from two directions having a predetermined angles in the longitudinal direction of the mesh sleeve. As for such a material for the mesh sleeve, CLEAN CUT PET (CLEAN CUT is a trademark of TECHFLEX Inc. registered in the Patent and Trademark Office in the United States) manufactured by TECHFLEX Inc. (located in New Jersey, U.S.A.) can be cited.

The inner tube 1 which is covered by the mesh sleeves 5 and 6 is plugged by the rubber plugs 2 and 3 and fixed at opposite ends of the inner tube in longitudinal direction as shown in the diagram. According to the method of fixation, the rubber plugs 2 and 3 are inserted into the inner tube 1 at both ends. Next, the inner tube being attached with the rubber plugs 2 and 3 are inserted into the mesh sleeve 5 cut in the length that is a little longer than the inner tube 1. Further, the outer periphery of the mesh sleeve 5 is covered with the mesh sleeve 6. The length of the mesh sleeve 6 is to be approximately the same as the inner tube 1. After that, the end portion of the mesh sleeve 5 is folded back in the direction toward the center and inserted into the mesh sleeve 6, and the inner tube 1 and the mesh sleeves 5 and 6 are fastened to the rubber plugs 2 and 3 by the stoppers. The end portions of the mesh sleeve 5 being folded back and fastened to the rubber plugs 2 and 3 are formed into the shape that can be connected to a hook attached to the load. In order to insert the air supply/discharge tube 4 into the rubber plug 2 covered with the mesh sleeve 5, a part of the mesh sleeve 5 is stretched out.

Endurance test for both the pneumatic actuator of the present invention configured as above and the conventional pneumatic actuator was carried out in the manner as shown in FIG. 4. The specification of the pneumatic actuator is as follows:

the rated diameter of the material of the mesh sleeves 5 and 6 is 1.5 inches;

the external diameter of the mesh sleeve when unloaded is about 30 mm;

the external diameter of the mesh sleeve when loaded to the maximum is about 50 mm; and

the length of the pneumatic actuator when unloaded is 400 mm. A 30 kg of plummet is suspended from the actuator. Then as an endurance test, a method was employed to repeat the condition of FIG. 4 (a) and FIG. 4 (b) alternately (repeat supply and discharge of air) by 10 cycles/minute using the compressor connected to the air supply/discharge tube.

The pneumatic actuator comprising the conventional onefold mesh sleeve 5, when the test proceeds over several thousand times, the portions in the vicinity of opposite ends of the mesh sleeve 5 configuring the actuator starts to deform into a spherical form having the diameter larger than the one of the central portion (refer to FIG. 5). Once the mesh sleeve 5 starts to deform into spherical forms, the gaps among the mesh in the spherical deformed portion are broadened and the inner tube 1 starts to stick out from those gaps. Then the inner tube 1 protruded from the gaps in the mesh starts to deteriorate due to friction caused by being pinched between the mesh when the air is discharged. In due time the inner tube gets damaged which leads to air leakage, and the actuator lapses into inoperative condition.

On the contrary, the pneumatic actuator comprising the double structured mesh sleeves 5 and 6 to which the present invention is applied does not cause the deformation in the vicinity of opposite ends of the mesh sleeve 5 which configures the actuator even as the endurance test proceeds. In the pneumatic actuator of the present invention, the mesh sleeve 5 expands/contracts while maintaining the uniform diameter over approximately the entire length even when the endurance test proceeds with repetition of supply and discharge of air. Therefore, even in the vicinity of opposite ends of the mesh sleeve 5, as is in the central portion, broadening of the gaps among the mesh does not take place since the length of the tube shrinks for the portion of the enlarged diameter. Consequently, damage from the friction due to the inner tube 1 being pinched in the gap of the mesh sleeve 5 can be prevented. In addition, the pneumatic actuator comprising the double structured mesh sleeve lapses into inoperable condition after repeating the operation over several hundreds of thousands of times, due to fatigue subsidiary fracture in the rubber of the inner tube 1.

As shown in the result of the endurance test in chart 1, in the pneumatic actuator of the present invention, the number of times of repeating operation from the start of the test to the breakage is improved by the degree of 5.5˜9 times compared to the pneumatic actuator covering the inner tube with only the conventional onefold mesh sleeve 5. Among the samples having the double structured mesh sleeves 5 and 6, there was one having about 10 times longer life span than the single structured actuator though not shown in chart 1. From the result of this endurance test, superiority of the pneumatic actuator to which the present invention is applied has been confirmed.

CHART 1

| | | No. of cycles until |
|---|---|---|
| Ref. # | Form of Mesh Sleeve | breakage |
| 1 | Onefold | 145,000 |
| 2 | Onefold | 96,000 |
| 3 | Onefold | 130,000 |
| 4 | Twofold | 851,000 |
| 5 | Twofold | 660,500 |
| 6 | Twofold | 525,000 |

Next, the second embodiment of the present invention will be described referring to FIG. 2. FIG. 2 shows the cross-sectional view of the pneumatic actuator of the second embodiment of the present invention. In this embodiment, the material being used for the second mesh sleeve 11 in this embodiment is different from the first mesh sleeve 5 used in the first embodiment, for example, in that the material has higher heat resistance or abrasion resistance. Such material high in heat resistance or abrasion resistance is, for example, a braided wire rod (filament) of Teflon fiber, and its mesh is braided so as to be crossed from two directions having a predetermined angle toward the length direction of the mesh sleeve. As for such material for the mesh sleeve, TEFLON (TF) (Teflon is a Registered Trademark of Dupont Company) manufactured by THECHFLEX Inc. can be cited. The pneumatic actuator of the present embodiment, as is the first embodiment, is improved in its heat resistance along with durability, thus can be used in high-temperature atmosphere.

Next, the third embodiment of the present invention will be described referring to FIG. 3. FIG. 3 is a cross-sectional view of the pneumatic actuator of the third embodiment related to the present invention. In this embodiment, compared to the first embodiment, it is different in a point that a thecal low friction body 12 having smaller coefficient of friction with respect to the second mesh sleeve 6 than the one of the first mesh sleeve is placed between the first mesh sleeve 5 and the second mesh sleeve 6. This low friction body 12 is placed so as to cover the entire first mesh sleeve 5, and is fastened and fixed to the rubber plugs 2 and 3 together with the inner tube 1 and the mesh sleeve 5 and 6 using a stopper. As for the material for the low friction body, elastic fabric used for stockings, etc. can be used. Such fabric is made up of, for example, synthesized fabric combining a core fiber of polyurethane with a nylon fiber. The pneumatic actuator of the present embodiment is capable of reducing the loss of driving force due to friction between the mesh sleeves 5 and 6, along with preventing the damage due to the friction between mesh sleeves 5 and 6, whereby capable of prolonging the life span of the actuator.

While the present invention has been described above based on the embodiments, various changes may be made without departing from the scope of the invention. The present invention can be summarized that it is characterized in comprising means for preventing or suppressing the local deformation in the vicinity of opposite ends of the first mesh sleeve 5. While the wrapping body (mesh sleeve) is configured having double structure as means to prevent or suppress the local deformation in opposite ends of the first mesh sleeve 5 in embodiments 1˜3, the wrapping body may have three or more layered structure. Also, the same effect as the first embodiment can be attained, when the fluid is supplied to the expansible/contractible body or in the process of supplying fluid, by covering the portions in the vicinity of opposite ends of the mesh sleeve with the member having the same rate-of-change of the diameter as the rate-of-change of the diameter in the center portion of the mesh sleeve 5 in order to prevent the local deformation in the vicinity of opposite ends of the mesh sleeve 5.

Also, while the pneumatic actuator that uses air as fluid is described in the above embodiments, the fluid to be supplied to the expansible/contractible body does not have to be limited to air, and a variety of fluids such as water, oil and gas can be used according to the purpose of usage.

The pneumatic actuator related to the present invention can be used as a driving actuator for a rehabilitative equipment (for example, CPM (Continuous Passive Motion) device) or care-giving equipment. Also, it can be used as a driving actuator for wearable robot suits, which is an artificial muscle. Further, it can be applied to industrial robots or construction equipment. Through the improvement of the durability of the fluid pressure type actuator by the present invention having such wide range of application, further expansion of its application can be expected

1. A fluid pressure type actuator comprising:
a expansible/contractible body sealed by plug members at both ends and expands/contracts by supply/discharge of fluid therein/therefrom;
a first wrapping body which wraps the outer periphery of the expansible/contractible body, fastened and fixed to the plug members at opposite ends;
an inlet/outlet for fluid formed in the plug members; and
an auxiliary member, when fluid is supplied to the expansible/contractible body, for expanding the first wrapping body in a uniform diameter over approximately the entire length of the wrapping body including the vicinity of the opposite ends.

2. The fluid pressure type actuator according to claim 9, wherein the auxiliary member is a second wrapping body fastened and fixed to the plug members at opposite ends, which wraps the first wrapping body.

3. A fluid pressure type actuator comprising:
an expansible/contractible body sealed by plug members at both ends and expands/contracts by supply/discharge of fluid therein/therefrom;
a double structured wrapping body wherein opposite ends of the first wrapping body which wraps the outer periphery of the expansible/contractible body and the second wrapping body which wraps the outer periphery of the first wrapping body are fastened and fixed to the plug members; and
an inlet/outlet of fluid formed in the plug members.

4. The fluid pressure type actuator according to claim 2, wherein the first wrapping body and the second wrapping body are formed by a mesh-like thecal body of which the diameter increases and the length reduces when the expansible/contractible body expands due to supply of the fluid.

5. The fluid pressure type actuator according to claim 4, wherein the first wrapping body and the second wrapping body have the same diameter, material and the number of wires of the mesh.

6. The fluid pressure type actuator according to claim 4, characterized in that the first wrapping body and the second wrapping body have different characteristics.

7. The fluid pressure type actuator according to claim 6, characterized in the first wrapping body and the second wrapping body, that the one has higher heat resistance than the other.

8. The fluid pressure type actuator according to claim 6, characterized in the first wrapping body and the second wrapping body that the one has superior friction resistance compared to the other.

9. The fluid pressure type actuator according to claim 3, characterized in comprising a multiple structured wrapping body which wraps the first wrapping body and the second wrapping body with at least a third or more layer of wrapping body.

10. The fluid pressure type actuator according to claim 3, characterized in comprising a thecal low friction body between the first wrapping body and the second wrapping body, formed by material having smaller friction coefficient with respect to the second wrapping body than that of the first wrapping body.

11. A fluid pressure type actuator comprising:
an expansible/contractible body sealed by plug members at opposite ends, and expands/contracts by supply/discharge of fluid thereto/therefrom;
a wrapping body which wraps the outer periphery of the expansible/contractible body, fastened and fixed to the plug members at opposite ends;
an inlet/outlet of fluid formed in the plug members; and
an auxiliary member for preventing or suppressing the local deformation in which the wrapping body expands outwards when the fluid is supplied to the expansible/contractible body.
